(19) United States
(12) Patent Application Publication
(10) Pub. No.: US 2001/0056363 A1
(43) Pub. Date: Dec. 27, 2001

(54) System for providing ride matching services using e-mail and the internet

(76) Inventors: Donald T. Gantz, Fairfax, VA (US); John R. Gray, Oakton, VA (US)

Correspondence Address: Roland H. Shubert, Post Office Box 2339, Reston, VA, 20195, US

(21) Appl. No.: 09/886,209

(22) Filed: Jun. 22, 2001

Related U.S. Application Data
(60) Provisional application No. 60/213,917, filed on Jun. 26, 2000.

(51) Int. Cl. G06F 17/60

(52) U.S. Cl. 705/9; 705/5; 705/13; 705/10

(57) ABSTRACT

An on-line ride sharing system employs a dynamic database of geographical information in map form together with information that is input into the system by individual users and potential users of the system. An analysis program is integrated with the database to evaluate applications filed by users, and to present a user with a map display of origin and destination locations of potential ride sharing partners. A communication route is provided by the system between the user and potential partners to allow the parties to maintain anonymity and privacy so long as is desired.

### BACKGROUND OF THE INVENTION

1. Technical Field

This invention relates to a system and program to provide a simple and readily accessible method for commuters to locate and communicate with potential ride sharing partners.

More particularly, this invention relates to a method and means to provide commuters throughout a metropolitan area with access to and use of dynamically managed web pages and associated databases that operate in real time, allow direct and near-immediate communication between potential ride sharing partners, avoid third party intervention between riders, and preserve the anonymity and privacy of users.

2. Description of Related Art

Most of the highway and public transit systems in metropolitan areas within this country utilize a radial arrangement that was designed to transport people between a central hub and suburban areas surrounding that hub. However, as suburban development progressed, the bulk of the traffic congestion in many metropolitan areas now results from purely suburban commuting. The resulting and continually increasing congestion has let to an abiding interest in reducing auto traffic, particularly peak hour auto traffic, through ride sharing and carpooling.

There have been a variety of approaches taken to fostering and facilitating ride sharing and carpooling arrangements between and among commuters in metropolitan areas. Those approaches have ranged from data cards posted by individual employees on work place bulletin boards provided for that purpose to elaborate centralized systems operated by governmental or quasi-governmental entities. Ride sharing programs have been most successful along traditional commuting routes, but have had little impact on suburban commuting. In fact, often fewer than ten percent of the workers in major suburban employment centers commute by means other than single occupancy vehicles.

A number of problems have been identified that limit commuter use of and interest in traditional ride sharing programs. Those problems include the lack of real time feedback when using the programs, ride matches that are presented in the form of long lists with no visual references, no identification of geographic barriers that separate potential ride matches, a format that does not allow interaction between and among users but instead requires users to deal through a bureaucracy and correspond via the US mail, a requirement for third party intervention for initialization, and the use of proprietary networks that are not accessible to other commuters who are seeking ride sharing partners.

Other considerations have also limited the use of traditional ride sharing programs. One such consideration is the sacrifice of privacy and the attendant potential dangers arising out of the loss of control over access by strangers to personal information that is necessarily provided by a commuter who seeks to use the ride sharing program. In a typical ride sharing program, a stranger may gain access to the name, address, telephone number and commuting destination of a system user without the knowledge of, and without the prior approval and consent of that user.

The problems with existing approaches have served to limit the usefulness and success of conventional ride sharing programs. This invention provides a system that alleviates and overcomes the deficiencies inherent in present practices.

### SUMMARY OF THE INVENTION

This invention provides a user friendly and readily accessible system for commuters to locate and communicate with potential ride sharing partners using email and the Internet. A commuter seeking a ride sharing partner first accesses a web site to fill out a ride sharing application such as that one depicted in FIG. 1. The application will typically include a designation of origin and destination locations, the travel time frame, and an e-mail address. Immediately upon completing the application, the commuter is presented with maps of the designated origin and destination locations annotated with physical locations and e-mail addresses of potential carpool and vanpool matches. Thereafter, communication flows directly between the commuter and the potential ride sharing partners. The privacy and safety of the parties may be further enhanced causing the web site to create and assign temporary buffer identities for users of the system. That buffer identity may comprise a temporary e-mail address that requires all correspondence between negotiating parties to flow to and from the web site until the parties, on their own, choose to exchange personal e-mail addresses or telephone numbers.

It is therefore an object of this invention to provide a system for matching potential ride sharing partners without sacrificing the privacy of the participants.

Another object of this invention is to provide a ride sharing program that operates without intervention of any third parties.

Other objects will become apparent from the following description of preferred embodiments of the invention.

### BRIEF DESCRIPTION OF THE DRAWING

FIG. 1 illustrates a web page application that would allow a commuter to participate in the system;

FIG. 2 illustrates a web page map display of the starting and destination locations;

FIG. 3 illustrates a typical web page display of a starting location map indicating the starting locations of three ride match candidates;

FIG. 4 illustrates a typical web page display of a destination location map indicating also the destination locations of three ride match candidates; and

FIG. 5 illustrates a web page layout that allows a commuter to edit previously entered data, or to remove his entry from the database.

### DESCRIPTION OF PREFERRED EMBODIMENTS OF THE INVENTION

The ride sharing program of this invention provides a web-based, ride sharing system that furnishes users real time feedback, displays maps of origin and destination locations, allows near-immediate direct communication between potential partners, and provides unlimited “what if” capability, all without third party human intervention between riders, while also preserving the privacy of users and prospective partners. Those capabilities allow the system to accommodate a onetime ride share arrangement as well as long term ride matching.

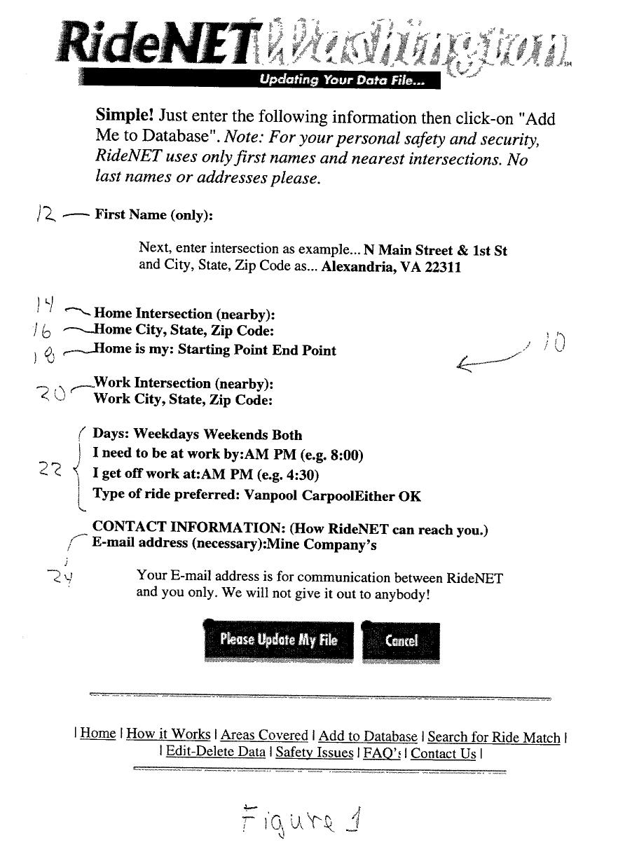

The ride matching system of this invention requires first that a web site be established that includes a database containing detailed maps of a particular commuting area such as, for example, the Washington, D.C. metropolitan area. To use the system of this invention, a user first enters data according to the query prompts provided by a web page such as that illustrated by FIG. 1. As is illustrated in that Figure, information that is required of a prospective user includes a first name 12, a street intersection nearby a home or origin location 14, the city, state and Zip code of the origin location 16, a designation 18 as to whether the origin location is the starting or the end point, a general designation of the work location 20, scheduling information 22, and the necessary contact information 24 which comprises simply the user's e-mail address. The e-mail address is used for communication between the user and the system web site only, and is not provided to any other user of the system. Unlike traditional ride sharing programs, personal identifying data such as last name, actual address, telephone numbers, and place of and actual address of work are not required by the system in order for it to work.

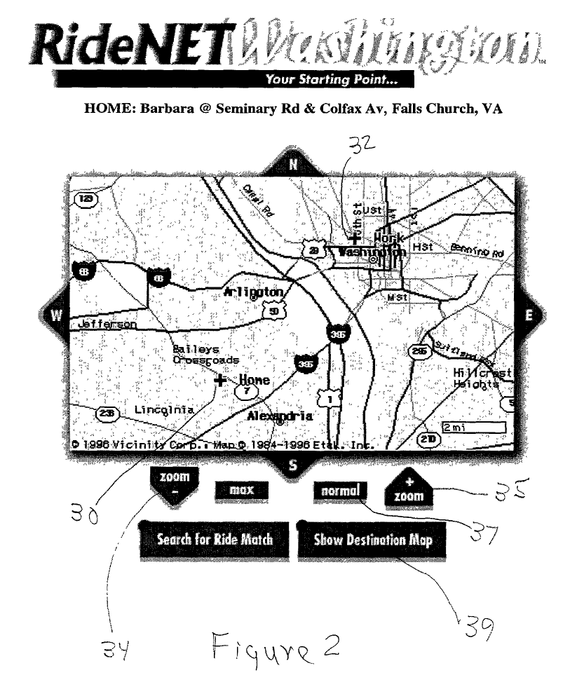

Upon entry of the requested information into the system database a user can call up a map, such as that one illustrated in FIG. 2, that shows the user's home location 30 and work location 32 in one view. Scale of the displayed maps can be changed at will using zoom buttons 34 and 35. An enlarged scale map of the starting location can be obtained by clicking on the normal symbol 37 while an enlarged scale map of the destination location is obtained by clicking on directional panel 39.

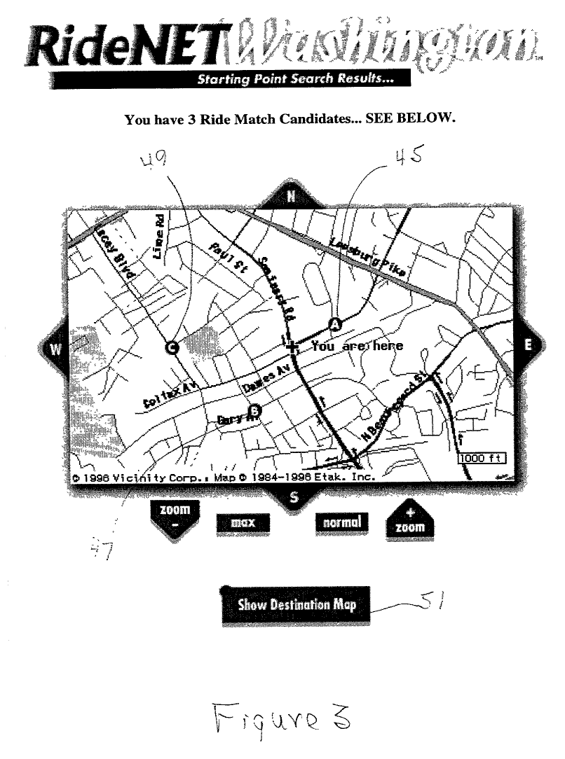

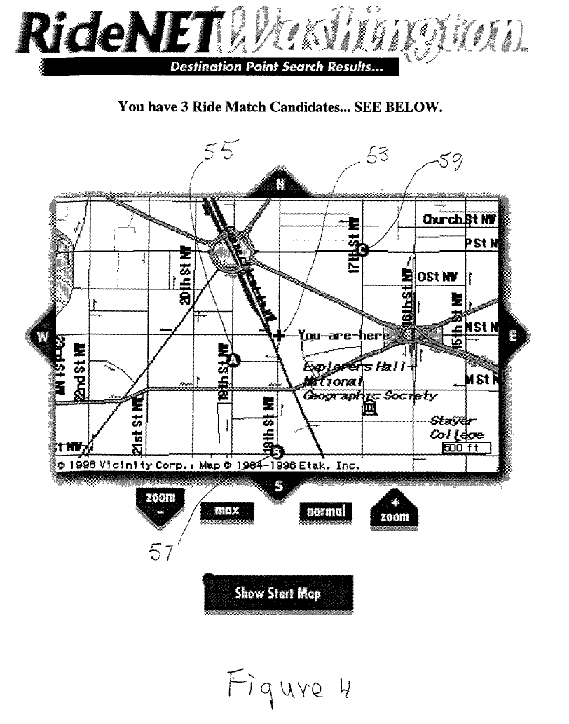

In a similar fashion, the system is directed to search for a ride match by clicking on directional panel 41. An analysis program is integrated with the database to evaluate applications filed by users and to provide an inquiring user with a visual map display of the physical locations of potential carpool matches, as well as to provide that user with a means for contacting the potential partner. The search for a ride match can be approached from either end, either the home or the destination location. So far as the system is concerned, it is the same search. FIG. 3 illustrates the manner in which results of a ride match search are displayed from the home location perspective, while FIG. 4 illustrates the manner in which the results from that same search are displayed from the destination location perspective. Looking first at FIG. 3, the home location that was entered into the system database by the user is indicated by the cross mark 43. In this illustrative example, the search turned up three ride match candidates A, B, and C, indicated on the FIG. 3 map at 45, 47 and 49 respectively. The FIG. 3 web page will then list for each candidate A, B, and C, a first name, a street intersection starting point, and an e-mail address. The e-mail address listed is preferably not the actual e-mail address of the candidate. Rather it preferably is a fictitious, or buffer, address that is assigned by the system to the candidate. That buffer address allows communication only between the user and the system and between the system and the candidate, thus preserving the anonymity and the privacy of both the user and the candidate.

Clicking on the destination map panel 51 then produces a new map display as is illustrated by FIG. 4. The work location that was entered into the system database by the user is indicated at 53. The destination locations of each of the three ride match candidates, A, B, and C, are shown on the FIG. 4 map at 55, 57 and 59 respectively. At this point the user may select among the potential candidates and initiate contact with the selected candidate or candidates by means of a message directed to the candidate's buffer email address. At this stage, all correspondence between the user and the candidates flows back and forth through the system web site through buffer addresses ensuring total anonymity of the correspondents. That anonymity is maintained until one of the parties supplies the other with an alternative communication route, either an actual e-mail address or a telephone number. At that point, the parties bypass the system and correspond directly, one with the other.

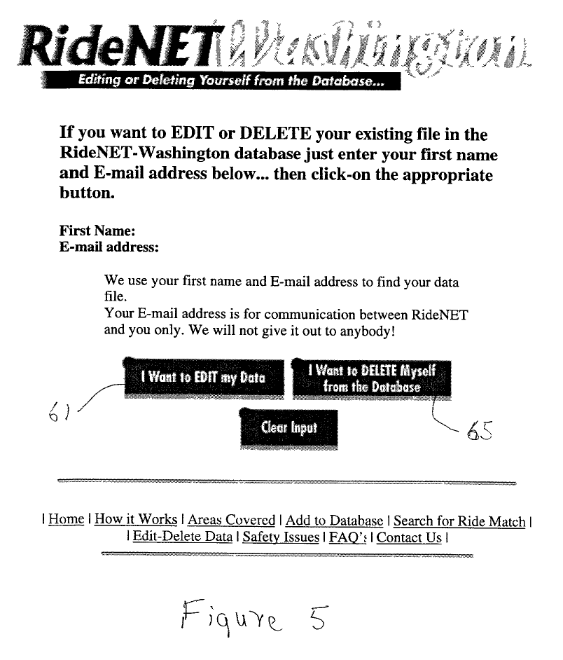

There are several options available to a user who does not find the ride match candidates turned up in the search to be to his liking. The user may change some of his preferences, arrival and departure times for example, and run the search again. That may result in presenting the user with a new suite of candidate ride sharing partners. The user may leave his name within the database in the hope or expectation that a new ride match will appear as new users register with the system, or the user may remove himself from the ride pool database altogether. The system web site allows for changing preferences as is shown in the web page that is depicted in FIG. 5. A preference change may be carried out by clicking on the edit panel 61 that causes the data entry screen depicted in FIG. 1 to appear. Changes can then be entered into the screen questionnaire and can thereafter be entered into the system database by clicking on the update panel 63. In similar fashion, a user may opt out of the system and delete all relevant data from the system database by clicking on the delete from database panel 65 of FIG. 5.

In a preferred embodiment, the maps contained within the system database are annotated to identify and display potential geographic barriers that might interfere with travel between potential ride sharing partners and between potential origin and destination locations. Such geographical barriers, for example, may comprise limited access highways, streams that are only occasionally bridged, railways, and the like. That map information allows a commuter to easily and directly analyze the barrier situation applicable to his specific circumstances, and to select potential ride sharing partners accordingly.

It can thus be appreciated that the ride matching system of this invention is a great improvement over conventional programs in that it operates in near real time without intervention of a third party bureaucracy while preserving the anonymity and privacy of its users and potential users.

Although the invention has been described and illustrated in terms of certain specific embodiments, various modifications and alterations to the described system may be made without departing from the spirit and scope of the invention as it is defined by the appended claims.

We claim:

1. A method for identifying and matching partners to share rides between a first location and a second location within a commuting area comprising:
establishing an Internet based web site;
creating a database containing detailed maps of said commuting area;
adding to the database information relating to a plurality of individual commuters, said information for each commuter including identifying indicia, the origin and the destination of the commute, and the time schedule of the commute;
providing an analysis program that is integrated with said database to obtain for an inquiring commuter, who furnishes to the web site personal information including origin and destination locations and a time schedule, a map display of the origins and destinations of potential ride sharing partners, and
providing means for the inquiring commuter to correspond with said potential partners.

2. The method of claim 1 wherein said identifying indicia comprise an e-mail address that allows communication between said each of said commuters and the web site.

3. The method of 1 wherein said inquiring commuter is provided an e-mail address allowing communication to and from the web site.

4. The method of claim 1 wherein said map display is arranged to identify geographic barriers that might interfere with travel between said inquiring commuter and potential ride sharing partners.

5. The method of claim 1 wherein said map display plots the origin and destination of said inquiring commuter in relation to the origin and destination of each of said potential ride sharing partners.

6. The method of claim 1 wherein the origin and destination of said commuter are identified as a nearby street intersection.

7. The method of claim 1 wherein the origin and destination of each of said potential ride sharing partners is identified as a nearby street intersection.

8. The method of claim 1 wherein means are provided that allow said inquiring commuter to edit said personal information or to delete it from said web site at will.

9. The method of claim 1 wherein the scale of said map display may be changed at will.

10. The method of claim 1 wherein said analysis program also provides a listing of said potential ride sharing partners.

11. A method for maintaining the privacy of a person while said person identifies potential partners for ride sharing between a first location and a second location within a commuting area comprising:
establishing an Internet based web site;
creating a database that contains detailed maps of said commuting area, said database also containing information relating to a plurality of other individuals commuting between various locations within said commuting area, said information including the origin, destination and time schedule of each of said other individual's commute;
assigning identifying indicia to said person, said indicia allowing communication only between the person and the web site;
assigning identifying indicia to each of said other individuals, said indicia allowing communication only between each one of said individuals and said web site;
selecting potential ride sharing partners from among said other individuals and furnishing to said person a map display of the origins and destinations of said potential ride sharing partners,
forwarding through said web site messages from said person directed to one or more potential ride sharing partners and forwarding replies to said messages, to thereby allow said person to maintain anonymity until a ride sharing partner has been identified.

12. The method of claim 11 wherein said identifying indicia is a buffer e-mail address that allows communication only between the addressee and the web site.

13. The method of claim 11 wherein the commute origins and destinations of said other individuals are identified as a nearby street intersection.

14. The method of claim 11 wherein potential ride sharing partners are identified through an analysis program that is integrated with said database.
